(19) United States
(12) Patent Application Publication
(10) Pub. No.: US 2004/0262922 A1
(43) Pub. Date: Dec. 30, 2004

(54) Assembly system for a pipe coupling

(75) Inventor: Pontus Andersson, Angelholm (SE)

Correspondence Address: WEINGARTEN, SCHURGIN, GAGNEBIN & LEBOVICI LLP, TEN POST OFFICE SQUARE, BOSTON, MA, 02109, US

(73) Assignee: Lindab AB

(21) Appl. No.: 10/608,995

(22) Filed: Jun. 27, 2003

(51) Int. Cl. F16L 17/00; F16L 19/00

(52) U.S. Cl. 285/365

(57) ABSTRACT

An assembly system for coupling a first pipe element (2) and a second pipe element (3) has a circumferential clamping device (5) to be applied on the outside of the ends of the pipe elements and to be tightened around the same when the two pipe elements (2, 3) are placed end-to-end. The system also has a coupling device (6) to be arranged between the ends of the first and the second pipe elements (2, 3) and beneath the circumferential clamping device (5), so as to align and/or hold the two pipe elements (2, 3) during the assembly. A method of coupling a first pipe element (2) and a second pipe element (3) is also disclosed, as well as a coupling device (6) and use of the assembly system (1).

### FIELD OF THE INVENTION

The present invention relates to an assembly system for a pipe coupling, said system comprising a first pipe element, a second pipe element and a circumferential clamping device to be applied on the outside of the ends of the pipe elements and to be tightened around the same when the two pipe elements are placed end-to-end.

The invention also relates to a method for coupling a first pipe element and a second pipe element as well as to a coupling device for an assembly system for a pipe coupling.

The invention primarily relates to pipe couplings, wherein the pipe elements are made of sheet metal. For instance, if the cross-section of the pipe elements is round, oval or elliptic, the pipe elements may be spirally or helically-wound lock-seam tubes or pipes. If the cross-section of the pipe elements is for instance three, four or five sided, the pipe elements may be of welded or bent sheet metal.

The pipe elements related to the present invention are applicable to many different types of piping system, for instance ventilation duct systems and duct systems for conveying finely divided materials.

### BACKGROUND ART

It is known in the prior art to assemble two pipes end-to-end. If the assembly is of the male/female type, use is often made of fastening means such as screws or rivets. The use of fastening means has the disadvantage that the fitter assembling the pipes has to use extra tools for drilling holes for the fastening means. Furthermore, the use of tools is very cumbersome for the fitter due to the fact that the pipes often are placed near the ceiling in the room, which causes high discomfort in the working position for the fitter.

Prior-art design and assembly systems for pipe couplings using fastening means which are available on the market, are shown in Applicant's catalogue “Monteringsanvisning för LindabSafe” (Assembly instruction for LindabSafe) of May 1998.

Also when the pipes are to be cleaned, the known pipe systems have the disadvantage that the equipment cleaning the interior of the pipes may be damaged by the screws and rivets. In addition, if the pipe systems in which fastening means have been used, are to be disassembled and afterwards reassembled, the original holes cannot be reused. Accordingly, new holes are necessary for the reassembly, and thus tools are to be used again. It is also necessary to seal all the original holes in order to obtain a tight pipe coupling.

Further prior-art methods are known for coupling pipes. For instance, Applicant's PCT Publication Wo 96/07848 discloses how a so-called clamping band is tightened around circumferential end beads of two pipes which are arranged end-to-end. This known clamping band is annular and its cross-section is U-shaped, the flanges of which are directed towards the pipes and arranged on each side of the end beads, and the web of which is placed radially outside the end beads. In the coupling operation, the clamping band is tightened around the end beads by means of a clamping mechanism, and in a preferred embodiment there is a seal between the inside of the clamping band and the outside of the end beads.

Furthermore, prior-art design and assembly systems for pipe couplings which are available on the market, are shown in Applicant's catalogue “Ventilation 2000” issued in 2000, see for instance page 255.

Another known prior-art document relating to the coupling of pipes using clamping bands is Applicant's publication EP-A-849,518.

These prior-art clamping bands function in a satisfactory manner in terms of structure, but certain drawbacks arise during mounting. The fitter must in fact hold the ends of the two pipes joined at the same time as applying and tightening the clamping band. Since piping systems, e.g. ventilation ducts, where such clamping bands are used, are often placed in a position high above the floor, the fitter usually stands on a manlift and handles the clamping band in the original mounting of the pipes or, as mentioned above, dismounting thereof for cleaning purposes. Holding the two pipes with one hand and tightening the clamping band with the other hand is a complicated operation for the fitter, especially if he also has to work in an uncomfortable working position. If it comes to the worst, for instance in connection with large pipe dimensions, two fitters may be required to couple together pipes by means of clamping bands of the above-mentioned type. Furthermore, if different types of pipes are to be coupled, for instance horizontal and vertical pipes or an angle joint, the fitter often experiences that the displacement of the different elements which are to be coupled is too large, thus requiring several fitters in order to provide a secure coupling.

Sealing means are often arranged in connection with the clamping bands, providing a further drawback of these prior-art clamping bands. This may lead to sealing problems in the joint between the two clamping band ends where the clamping mechanism is arranged. This problem is stressed especially by the fact that the seal placed on the inside of the clamping band usually is slotted and has its opposite ends in the area of the joint between the opposite ends of the clamping band. Furthermore, due to the disadvantages mentioned above regarding the handling of the pipe ends during the assembly, displacements of the pipe ends in relation to each other often occur, which leads to the further drawback that the sealing of the coupling is non-satisfactory or even damaged during the assembly.

There is thus a need for a more rational method and an improved system for coupling together pipes of the above-mentioned type.

### SUMMARY OF THE INVENTION

An object of the present invention is to wholly or partly overcome the above disadvantages and drawbacks of the prior art. More specifically, it is an object to provide a system which is easy to mount and handle for one fitter during the assembly.

Another object of the present invention is to provide a system which secures an alignment of the pipe elements during the assembly.

It is also an object of the present invention to provide a system which avoids the use of tools during the assembly.

It is furthermore an object of the invention to provide a system which results in a rigid connection of two pipe elements.

It is moreover an object of the present invention to provide a system which may easily be assembled and disassembled.

The present invention is new and characterised by a coupling device to be arranged between the ends of the first and the second pipe elements and beneath the circumferential clamping device, so as to align and/or hold the two pipe elements during the assembly.

As a result, it is uncomplicated for one fitter to assemble two pipe elements due to the fact that the coupling device is arranged to align and/or hold the two pipe elements during assembly.

During mounting of the system according to the present invention, the fitter who is going to assemble the pipe elements initially places the first pipe element in position, then applies the circumferential clamping device on the outside of the first pipe element in an untightened position. Afterwards, the coupling device is arranged in such manner that it engages the end of the first pipe element and, subsequently, the end of the second pipe element is placed so that it engages the coupling device, so that the coupling device aligns and/or holds the two pipe elements. Finally, the fitter applies the circumferential clamping band on the outside of the ends of the pipe elements and outside the coupling device which is arranged between the ends of the pipe elements and tightens it around the same, so as to provide a secure and fixed assembly.

By the inventive system, the fitter has, during assembly, complete control over the pipe elements when placed end-to-end. Due to the fact that the coupling device both holds and/or aligns the end of the pipe elements, the fitter can concentrate his efforts on mounting the clamping device in the right manner, without holding the end of the pipe elements so that a tight fixation of the pipe elements is secured. Furthermore, the use of tools is completely avoided. A further advantage is that the pipe coupling may be disassembled in a simple way, for instance for purposes of cleaning the interior of the pipe elements or for restructuring of the pipe elements in relation to each other, and afterwards be reassembled without the use of any tools. The pipe elements are held together even during disassembly and do not immediately fall apart. As a consequence, the assembly system is particularly flexible and may be reused several times.

In a preferred embodiment of the invention, the coupling device may have at least one coupling means extending outwardly in an axial direction towards the pipe elements. As a result, the coupling means is arranged to engage with the pipe elements and is thereby able to be held by and/or to hold the pipe elements.

Advantageously, according to the invention the coupling means may be arranged to engage the two pipe elements on their outward sides, so that an expedient assembly system is obtained.

According to the invention the pipe elements at their ends may have an outwardly directed circumferential bead or flange. The pipe elements may be provided with outwardly directed circumferential beads or flanges for simplifying connection and for strengthening their rim or end, since the ends of the pipe elements otherwise may be damaged during packaging and transportation. If the ends of the pipe elements are damaged, the pipe elements are often difficult to couple as they are placed end-to-end. By providing the ends of the pipe elements with beads or flanges, the ends of the pipe elements obtain a much higher radial strength.

Furthermore, according to an aspect of the invention said coupling device may be a ring comprising a first and a second coupling means, where the first coupling means is adapted to outwardly engage the first pipe element or the bead or flange of the first pipe element and the second coupling means is adapted to outwardly engage and/or hold the second pipe element or the bead or flange of the second pipe element. During the assembly, the first coupling means of the ring is applied so that it engages the first pipe element or the bead or flange of the first pipe element on the outside. Then the second pipe element is placed in position so that the second coupling means of the ring outwardly engages the second pipe element or the bead or flange of the second pipe element. Accordingly, a system which is simple to use and which may be incorporated in existing pipe couplings without structure-wise alteration is obtained. Furthermore, only one fitter is necessary for assembling the system, the fitter can concentrate his efforts on applying the circumferential clamping device without having to focus on holding the end of pipe elements, tools are avoided and a rigid coupling is provided. In addition, a more flexible assembly system is obtained as the pipe elements via the coupling device may be brought into engagement in several ways, for instance from above, from below, from the sides or even in an inclined position due to the fact that the coupling device may be turned accordingly.

The term “ring” is in the context of this specification to be construed as any geometric configuration such as circular, elliptic, triangular, square, rectangular, five-sided, trapezoidal, octagonal, hexagonal, pentagonal, etc. The geometric configuration of the ring should be substantially identical to the cross-section of the pipe elements, which are to be assembled.

According to the invention, the coupling means may have a groove adapted to engage the beads or flanges of the pipe elements. As a result, the engagement of coupling device and the beads or flanges of the pipe elements is very secure and firm, due to the fact that the grooves of the coupling means outwardly mechanically engage and lock the pipe elements which are thereby held together in an expedient manner.

Advantageously, according to the invention, the coupling means may be adapted to engage a part of the pipe elements or the beads or flanges of the pipe elements. As a result, the coupling device is simple to apply to the pipe elements.

In an expedient embodiment according to the invention, the first coupling means may extend along part of the circumference of the ring so as to engage the first pipe element or the bead or flange of the first pipe element, and the second coupling means may extend along part of the circumference of the ring so as to engage the second pipe element or the bead or flange of the second pipe element. Hereby, a strong and secure pipe coupling is obtained.

According to a preferred embodiment of the invention, the first coupling means may be adapted to outwardly engage an upper part of the first pipe element or the bead or flange of the first pipe element, and the second coupling means may be adapted to outwardly engage and/or hold a lower part of the second pipe element or the bead or flange of the second pipe element. Thus, the coupling device is held by the first pipe element by the engagement of the first coupling means, and the second pipe element is held by the second coupling means of the coupling device in an expedient manner.

The ring may according to an aspect of the invention furthermore comprise a plurality of the first coupling means and a plurality of the second coupling means, which in turn are spaced apart along the circumference of the ring. Thus a simple coupling device is obtained, which has high flexibility.

The coupling means may also comprise friction enhancing means on the surface facing the pipe elements or the bead or flange of the pipe elements, thus increasing the coupling means adhesion to the pipe elements.

According to the invention, the coupling device may comprise sealing means. As a result, the coupling device may function as sealing of the pipe coupling so that the assembly is substantially tight and thereby essentially leakproof.

In an expedient manner the coupling device according to the invention may be made of plastic material, rubber material, metal or reinforced fibre material. A common feature of these materials is that they have a sufficiently high strength for holding the weight of the pipes.

Advantageously, the clamping device may be tightened around the ends of the pipe elements or the beads or flanges of the pipe elements and the coupling device by a locking mechanism, such as a straining screw or a snap lock, so that the use of extra tools in the assembly is avoided and hence a system which is easy to operate and mount is obtained.

According to one embodiment of the invention, the coupling device is an integrated part of the end of the first pipe element. Thus, a simplified system with few loose parts is achieved.

The invention also relates to a method for coupling a first pipe element and a second pipe element, use being made of an assembly system comprising a circumferential clamping device, which is applied on the outside of the ends of the pipe elements and tightened around the same when the two pipe elements are placed end-to-end. The method is new and characterised in that a coupling device is arranged between the ends of the first and second pipe elements to align and/or hold the two pipe elements during the assembly.

The invention furthermore relates to use of an assembly system as claimed in claims 1-15 for coupling a first pipe element and a second pipe element.

Finally, the invention relates to a coupling device for an assembly system for a pipe coupling. The coupling device is new and characterised by having at least one coupling means extending outwardly in the axial direction, said coupling means being arranged to engage the two pipe elements on their outside.

The coupling device according to the invention may be a ring comprising a first and a second coupling means, where the first coupling means is adapted to outwardly engage the first pipe element and the second coupling means is adapted to outwardly engage and/or hold the second pipe element.

Furthermore, according to the invention the first coupling means may be adapted to outwardly engage an upper part of the first pipe element and the second coupling means is adapted to outwardly engage and/or hold a lower part of the second pipe element.

### BRIEF DESCRIPTION OF THE DRAWINGS

The invention and its many advantages will be described in more detail below with reference to the accompanying schematic drawings, which for the purpose of illustration show some non-limiting embodiments and in which

FIGS. 1-7 show the assembly of a pipe coupling according to an aspect of the invention,

FIG. 8 shows the assembly system of FIGS. 1-7 in a sectional view,

FIG. 9 shows in perspective a first embodiment of the coupling device according to the invention,

FIG. 10 shows in perspective a second embodiment of the coupling device according to the invention,

FIG. 11 shows in perspective a third embodiment of the coupling device according to the invention, and

FIG. 12 shows in perspective a fourth embodiment of the coupling device according to the invention.

FIG. 13 shows in perspective a fifth embodiment of the coupling device according to the invention.

All drawings are schematic and not necessarily to scale, and they show only parts which are necessary in order to elucidate the invention, other parts being omitted or merely suggested.

### DESCRIPTION OF PREFERRED EMBODIMENTS

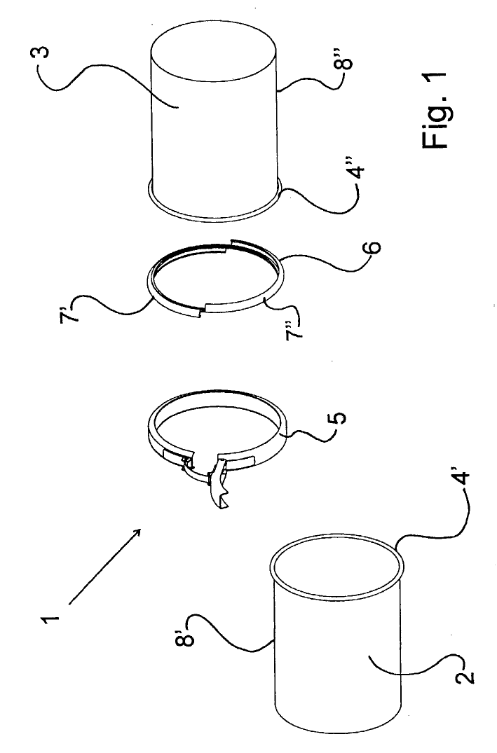

In FIG. 1, an assembly system 1 for a pipe coupling according to the invention is shown in exploded view. The assembly system 1 comprises a first pipe element 2 and a second pipe element 3, which in this embodiment have an outwardly directed circumferential end bead or flange 4′, 4″. In other embodiments according to the invention, the pipe elements may be without beads and flanges or have partial beads or flanges.

Furthermore, the assembly system 1 comprises a circumferential clamping device 5 to be applied on the outside of the end beads or flanges.

The assembly system 1 also comprises a coupling device or ring 6 to be arranged between the ends of the first 2 and the second 3 pipe elements and beneath the circumferential clamping device 5, so as to align and/or hold the two pipe elements 2, 3 during the assembly.

In this embodiment, the coupling device 6 has two coupling means 7′, 7″ extending outwardly in an axial direction towards the pipe elements 2, 3. The coupling means 7′, 7″ are arranged to engage the two pipe elements 2, 3 on their outward sides 8′, 8″.

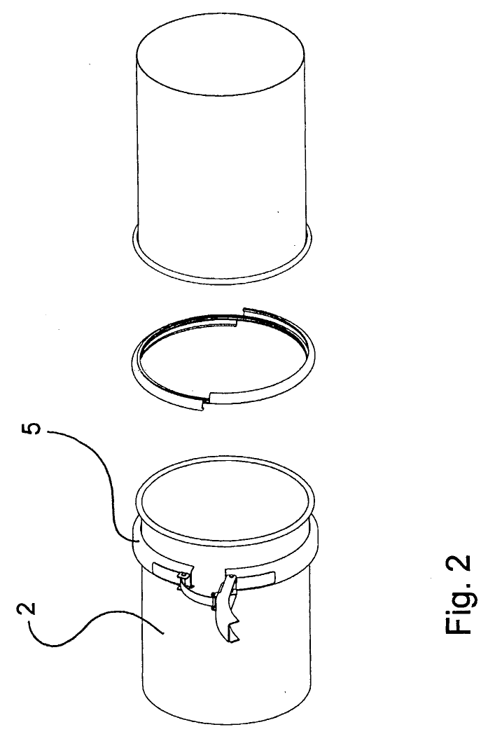

In FIG. 2, the circumferential clamping device 5 is applied on the outside of the first pipe element 2 in an untightened position. Alternatively, the clamping device 5 may be applied on the second pipe element 3.

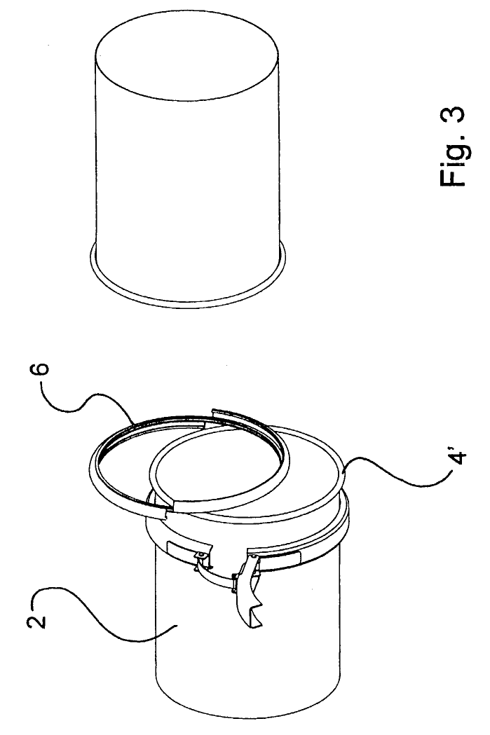

Subsequently, the coupling device 6 is brought into engagement with the bead 4′ of the first pipe element 2, as shown in FIG. 3.

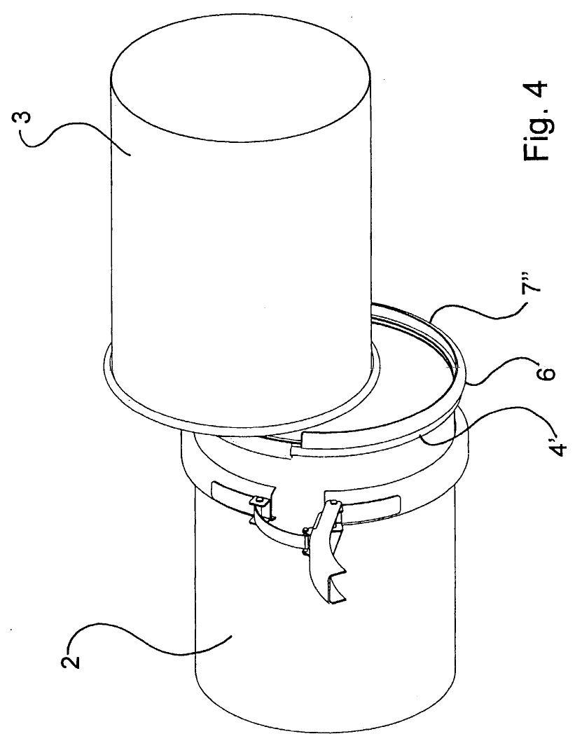

In FIG. 4, the coupling device 6 is shown in full engagement with the bead 4′ of the first pipe element 2. In this embodiment, the first coupling means 7′ outwardly engages the upper part of the bead 4′ of the first pipe element 2. Then, the second pipe element 3 is brought into engagement with the coupling device 6. The second pipe element 3 is in this embodiment brought into contact with the second coupling means 7″ of the coupling device 6 from above. In other embodiments of the present invention, the coupling device may be turned in such a manner that the second pipe element 3 is brought into engagement sideways, from below or inclined, whereafter the coupling device may be turned in position in order to hold and align the pipe elements.

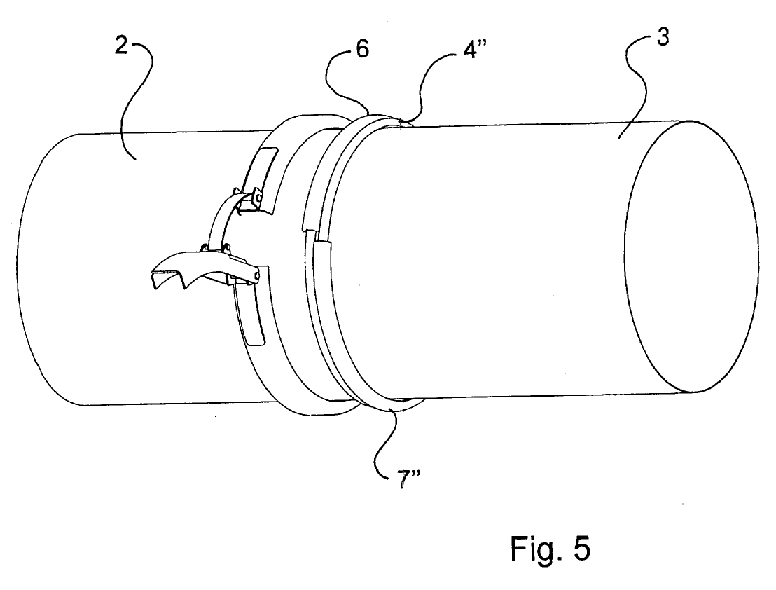

In FIG. 5 it is shown how the end of the second pipe element 3 is in full engagement and thereby abuts the end of the first pipe element 2 having the coupling device 6 there between. The second coupling means 7″ outwardly engages and thereby holds a lower part of the bead 4″ of the second pipe element 3.

Thus, the two ends of the pipe elements 2, 3 are essentially aligned with each other, whereby a secure fixation of the pipe coupling is obtained which is easy for the fitter to assemble.

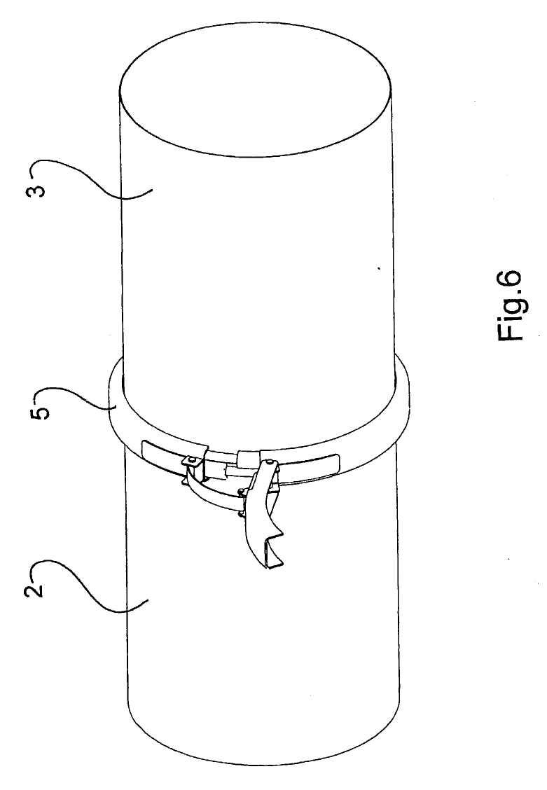

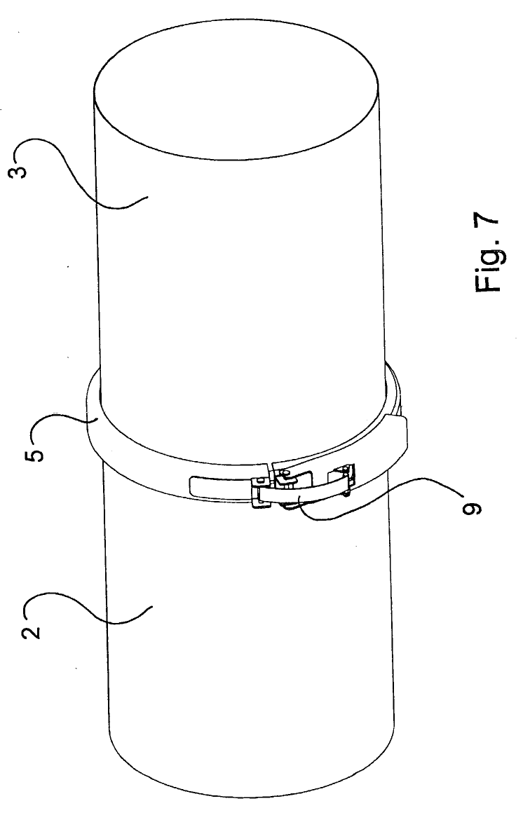

In FIG. 6, the circumferential clamping device 5 is applied on the outside of the end beads 4′ and the coupling device 6, and is tightened around the same when the two pipe elements 2, 3 are placed end-to-end as shown in FIG. 7.

In this embodiment, the locking mechanism 9 of the circumferential clamping device 5 is a snap lock. However, as will be appreciated by the skilled person, the locking mechanism 9 may also be a straining screw or the like.

The clamping device 5 need not necessarily be of the type shown in the figures, but could have the form of a guide rail or clips (not shown).

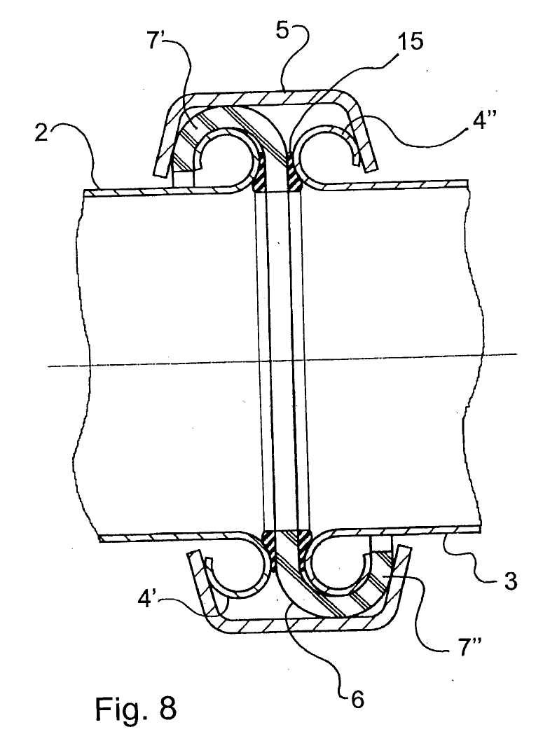

In FIG. 8, the above described assembly system is shown in an axial sectional view. In this embodiment, the outwardly directed circumferential beads 4′, 4″ are bent as an integrated part of the pipe element 2, 3, so that the bead substantially has the shape of a circle. However, as will be appreciated by the skilled person, the beads may have other configurations such as an inverted U (not shown). Furthermore, the beads may also be an additional part attached to the ends of the pipe elements (not shown).

In this embodiment it is easily deduced that the coupling means 7′, 7″ of the coupling device 6 outwardly engage the beads 4′, 4″ of the pipe elements 2, 3 and that the bead 4′ of the first pipe element 2 holds the ring or coupling device 6 and that the second coupling means 7″ holds the second pipe element 3.

Furthermore, the groove of the coupling means 7′, 7′ essentially has the form of a U, and thereby wraps or encircles the circular beads 4′, 4″. Thus, a secure fixation or mechanical locking is obtained. In other embodiments the groove may have a more square form for engaging, for instance, an outwardly directed circumferential flange of a pipe element. A common feature of all the grooves of the coupling means is that they may be formed to engage the beads or flanges in a secure manner.

Outside the end beads 4′, 4″ and the coupling device 6, the circumferential clamping device 5 is applied and tightened around the same, thereby securing and locking the pipe elements 2, 3 in relation to each other.

Advantageously, the coupling device 6 may comprise sealing means 15 so that the assembly is substantially completely tight and leakproof. The sealing means 15 may be applied in connection with the coupling means 7′, 7″ of the coupling device 6 or the coupling device itself may be produced of a material having sealing properties. Furthermore, the circumferential clamping device 5 may also comprise internal sealing means (not shown). When the clamping device is being locked around the bead, the clamping device 5 exerts an axial force on the beads 4′, 4″ so that the beads or flanges of the pipe elements 2, 3 are pushed together, thus obtaining an even tighter fixation.

A further advantage of the shown embodiment is that the coupling device 6 lies substantially flush with the inside of the pipe elements 2, 3, whereby an even interior assembly is obtained, which essentially gives no drop in pressure in the assembly.

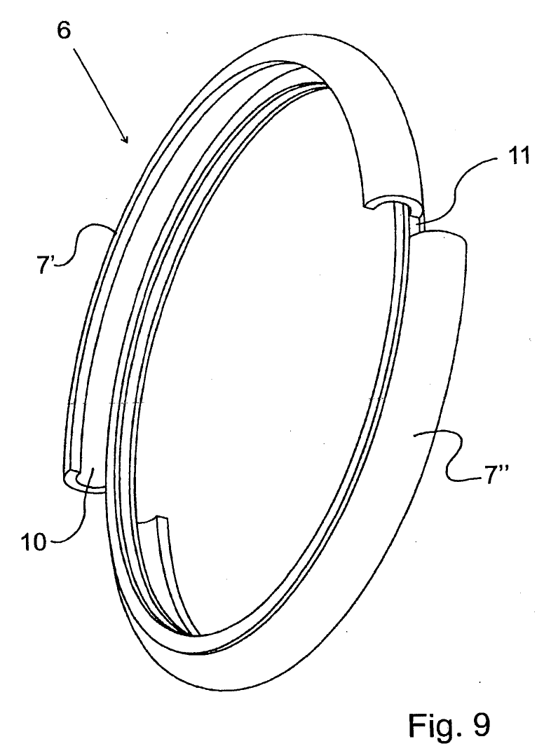

In FIG. 9, a first embodiment is shown, seen in perspective, of the coupling device 6 according to the invention. In this embodiment, the coupling device 6 is a ring comprising a first 7′ and a second 7″ coupling means. The semi-circular coupling means 7′, 7″ have a groove 10 adapted to engage the beads 4′, 4″ or flanges of the pipe elements 2, 3.

In this embodiment, the coupling means 7′, 7″ are adapted to engage a part of the beads 4′, 4″ or flanges of the pipe elements 2, 3. Furthermore, a gap 11 is arranged between the first and the second coupling means 7′, 7″, whereby a more flexible coupling device 6 is obtained.

The first coupling means 7′ extends along the upper part of the circumference of the ring 6, and the second coupling means 7″ extends along the lower part of the circumference of the ring 6.

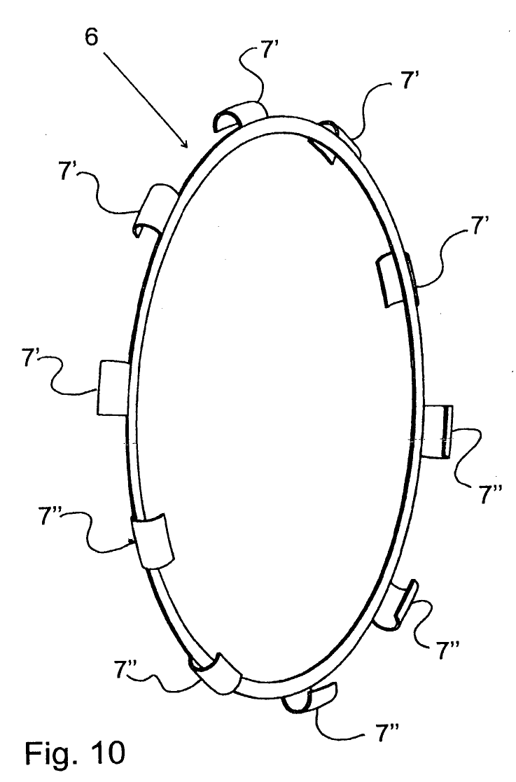

In FIG. 10, a second embodiment is shown, seen in perspective, of the coupling device 6 according to the invention. The coupling device 6 or the ring comprises a plurality of the first coupling means 7′ and a plurality of the second coupling means 7″, said first and second coupling means being spaced apart along the circumference of the ring 6.

In this embodiment, the first coupling means 7′ are also adapted to outwardly engage the upper part of the bead 4′ or flange of the first pipe element 2 and the second coupling means 7″ are adapted to outwardly engage or hold a lower part of the bead 4″ or flange of the second pipe element 3.

The coupling means 7′, 7″ are provided with grooves or so-called grip surfaces for engaging the beads or flanges.

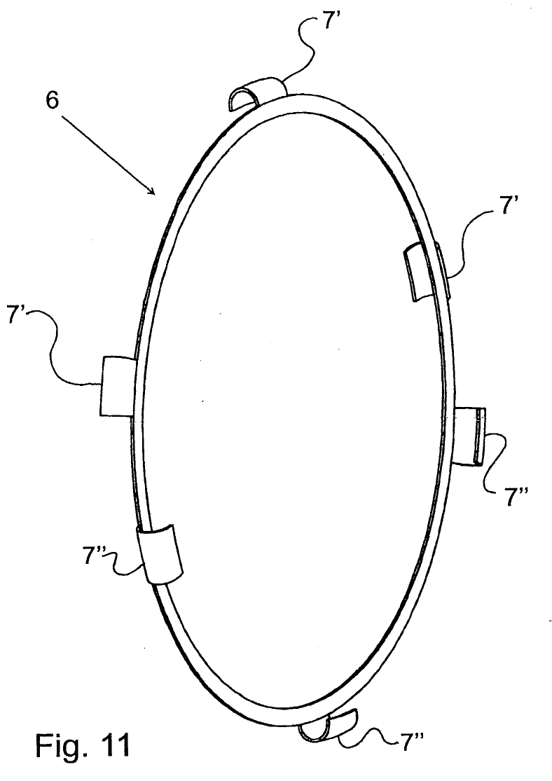

In FIG. 11, a third embodiment, seen in perspective, of the coupling device 6 according to the invention is shown. In this embodiment, the coupling device 6 or the ring also comprises a plurality of the first coupling means 7′ and a plurality of the second coupling means 7″, said first and second coupling means 7′, 7″ being spaced apart along the circumference of the ring 6. The ring 6 has three upper coupling means 7′ and three lower coupling means 7″. Within the inventive idea, the coupling device may have an arbitrary number of coupling means, as will be appreciated by the skilled person.

In this embodiment, the upper coupling means 7′ is arranged to hold the coupling device 6 in engagement with the bead or flange of the pipe element and the two coupling means at the side of the coupling device are arranged to hold and align the coupling device with the side of the pipe element.

Although the coupling means of the above mentioned embodiments are shown as primarily being placed at the upper part and the lower part of the coupling device, respectively, for outwardly engaging the upper part and the lower part of the beads or flanges of the pipe elements, the coupling means may —within the inventive idea —also be placed around a larger part of the circumference of the ring, for outwardly engaging a larger part of the circumference of the pipe elements.

Furthermore, according to the invention the coupling means may be provided with spring means so as to exert clamping forces on the outside of the pipe elements, and thereby ensure a tight fixation of the assembly (not shown).

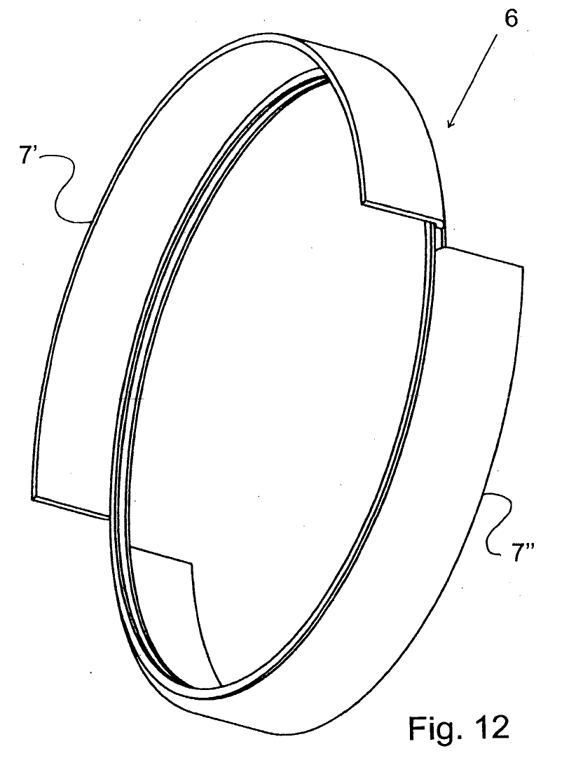

FIG. 12 shows in perspective a fourth embodiment of the coupling device 6 according to the invention. In this embodiment, the coupling device 6 is a ring comprising a first 7′ and a second 7″ coupling means. The semi-circular coupling means 7′, 7″ are adapted to engage the sides of the pipe elements having no beads or flanges.

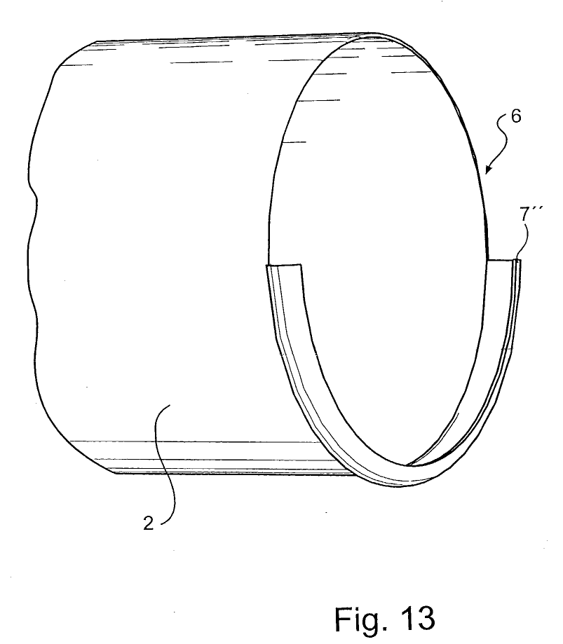

In FIG. 13 a fifth embodiment of the coupling device according to the invention is shown. In this embodiment, the coupling device 6 is an integrated part of the first or second pipe element.

For instance, the coupling device according to the invention may be made of plastic material, rubber material, metal or reinforced fibre material.

Although the invention above has been described in connection with preferred embodiments of the invention, it will be evident for a person skilled in the art that several modifications are conceivable without departing from the invention as defined by the appended claims.

While the invention primarily is described in connection with pipe elements having outwardly directed circumferential beads or flanges, the invention may also be used in relation to pipe couplings where the ends of the pipe elements have no beads or flanges or in relation to pipe couplings partly arranged with beads or flanges at their ends.

The invention is equally applicable to horizontal or vertical pipe elements as well as otherwise inclined pipe elements. The pipe elements may be e.g. pipes, elbows, reductions or T-junctions.

By using the assembly system having a coupling device according to the present invention, only one fitter is necessary for assembling the system. The fitter can concentrate his efforts on applying the circumferential clamping device without having to focus on holding the end of pipe elements, tools are avoided, a rigid coupling is provided and the system may be incorporated in existing pipe couplings without structure-wise alteration.

1. An assembly system for a pipe coupling, said system comprising:
a first pipe element and a second pipe element, the pipe elements each having an outwardly directed circumferential bead or flange,
a circumferential clamping device to be applied on the outside of the ends of said pipe elements and to be tightened around the same when said two pipe elements are placed end-to-end, and
a coupling device disposed between said ends of said first and said second pipe elements and beneath said circumferential clamping device, and configured to align and/or hold said two pipe elements during the assembly, said coupling device having at least one coupling means extending outwardly in an axial direction towards said pipe elements, and said coupling means configured to engage said two pipe elements on the outside of the pipe elements.

2. (Cancelled)

3. (Cancelled)

4. The system as claimed in claim 1, wherein each outwardly directed circumferential bead or flange is disposed at the end of the pipe element.

5. The system as claimed in claim 4, wherein said coupling device is a ring comprising a first and a second coupling means, where said first coupling means is adapted to outwardly engage said first pipe element or said bead or flange of said first pipe element and said second coupling means is adapted to outwardly engage and/or hold said second pipe element or said bead or flange of said second pipe element.

6. The system as claimed in claim 5, wherein said coupling means has a groove adapted to engage said beads or flanges of said pipe elements.

7. The system as claimed in claim 5, wherein said coupling means is adapted to engage a part of said pipe elements or a part of said beads or flanges of said pipe elements.

8. The system as claimed in claim 5, wherein said first coupling means extends along part of the circumference of said ring so as to engage said first pipe element or said bead or flange of said first pipe element, and said second coupling means extends along part of the circumference of said ring so as to engage and/or hold said second pipe element or said bead or flange of said second pipe element.

9. The system as claimed in claim 5, wherein said first coupling means is adapted to outwardly engage an upper part of said first pipe element or said bead or flange of said first pipe element and said second coupling means is adapted to outwardly engage and/or hold a lower part of said second pipe element or said bead or flange of said second pipe element.

10. The system as claimed in claim 5, wherein said coupling ring comprises a plurality of said first coupling means and a plurality of said second coupling means, said first and second coupling means being spaced apart along the circumference of said coupling ring.

11. The system as claimed in claim 5, wherein said coupling means comprises friction enhancing means on the surface facing said pipe elements or said bead or flange of said pipe elements.

12. The system as claimed in claim 1, wherein the coupling device comprises sealing means.

13. The system as claimed in claim 1, wherein said coupling device is made of plastic material, rubber material, metal or reinforced fibre material.

14. The system as claimed in claim 4, wherein said clamping device is tightened around said ends of said pipe elements or said beads or flanges of said pipe elements and said coupling device by a locking mechanism.

15. The system as claimed in claim 1, wherein the coupling device is an integrated part of said end of said first pipe element.

16. A method for coupling a first pipe element and a second pipe element, the pipe elements each having an outwardly directed circumferential bead or flange, said method comprising
applying a circumferential clamping device on the outside of said first pipe element in an untightened position;
arranging a coupling device in engagement with the end of said first pipe element;
bringing the end of said second pipe element into engagement with said coupling device, thus aligning and/or holding said two pipe elements during the assembly;
applying said circumferential clamping device on the outside of said ends of said pipe elements; and
tightening said circumferential clamping device around said ends of said pipe elements.

17. A method for coupling a first pipe element and a second pipe element, the pipe elements each having an outwardly directed circumferential bead or flange, use being made of an assembly system comprising a circumferential clamping device, which is applied on the outside of the ends of said pipe elements and tightened around the same when said two pipe elements are placed end-to-end, wherein a coupling device is arranged between said ends of said first and second pipe elements and in engagement with the two pipe elements on the outside of the two pipe elements, to align and/or hold said two pipe elements during the assembly.

18. Use of an assembly system as claimed in claim 1 for coupling a first pipe element and a second pipe element.

19. The use of the assembly system as claimed in claim 18, wherein each outwardly directed circumferential bead or flange is disposed at the end of the pipe element.

20. A coupling device for an assembly system for a pipe coupling including a first pipe element and a second pipe element, the pipe elements each having an outwardly directed circumferential bead or flange, said coupling device configured to be disposed between ends of said first and said second pipe elements, said coupling device having at least one coupling means extending outwardly in the axial direction, said coupling means configured to engage said two pipe elements on their outside.

21. The coupling device as claimed in claim 20, wherein said coupling device is a ring comprising a first and a second coupling means, where said first coupling means is adapted to outwardly engage said first pipe element and said second coupling means is adapted to outwardly engage and/or hold said second pipe element.

22. The coupling device as claimed in claim 21, wherein said first coupling means is adapted to outwardly engage an upper part of said first pipe element and said second coupling means is adapted to outwardly engage and/or hold a lower part of said second pipe element.

23. The coupling device as claimed in claim 21, comprising two semi-circular coupling means.

24. (Cancelled)

25. (Cancelled)

26. The system as claimed in claim 4, wherein the coupling device is an integrated part of said end of said first pipe element.

27. The system as claimed in claim 5, wherein the coupling device is an integrated part of said end of said first pipe element.

28. The system as claimed in claim 6, wherein the coupling device is an integrated part of said end of said first pipe element.

29. The system as claimed in claim 7, wherein the coupling device is an integrated part of said end of said first pipe element.

30. The system as claimed in claim 8, wherein the coupling device is an integrated part of said end of said first pipe element.

31. The system as claimed in claim 9, wherein the coupling device is an integrated part of said end of said first pipe element.

32. The system as claimed in claim 10, wherein the coupling device is an integrated part of said end of said first pipe element.

33. The system as claimed in claim 11, wherein the coupling device is an integrated part of said end of said first pipe element.

34. The system as claimed in claim 12, wherein the coupling device is an integrated part of said end of said first pipe element.

35. The system as claimed in claim 13, wherein the coupling device is an integrated part of said end of said first pipe element.

36. The system as claimed in claim 14, wherein the coupling device is an integrated part of said end of said first pipe element.

37. (Cancelled)

38. (Cancelled)

39. Use of an assembly system as claimed in claim 4 for coupling a first pipe element and a second pipe element.

40. Use of an assembly system as claimed in claim 5 for coupling a first pipe element and a second pipe element.

41. Use of an assembly system as claimed in claim 6 for coupling a first pipe element and a second pipe element.

42. Use of an assembly system as claimed in claim 7 for coupling a first pipe element and a second pipe element.

43. Use of an assembly system as claimed in claim 8 for coupling a first pipe element and a second pipe element.

44. Use of an assembly system as claimed in claim 9 for coupling a first pipe element and a second pipe element.

45. Use of an assembly system as claimed in claim 10 for coupling a first pipe element and a second pipe element.

46. Use of an assembly system as claimed in claim 11 for coupling a first pipe element and a second pipe element.

47. Use of an assembly system as claimed in claim 12 for coupling a first pipe element and a second pipe element.

48. Use of an assembly system as claimed in claim 13 for coupling a first pipe element and a second pipe element.

49. Use of an assembly system as claimed in claim 14 for coupling a first pipe element and a second pipe element.

50. Use of an assembly system as claimed in claim 15 for coupling a first pipe element and a second pipe element.
